(19) United States
(12) Patent Application Publication
(10) Pub. No.: US 2026/0211673 A1
(43) Pub. Date: Jul. 23, 2026

(54) AUTOMATED DOCUMENTATION GENERATION USING GENERATIVE ARTIFICIAL INTELLIGENCE

(71) Applicant: Dell Products L.P., Round Rock, TX (US)

(72) Inventors: Vedanta Vivek Patil, Hyderabad (IN); Mahtab Sandhu, Kurukshetra (IN); Vijaya P. Sekhar, Bengaluru (IN); Tousif Mohammed, Bangalore (IN); Bijan Kumar Mohanty, Austin, TX (US); Hung T. Dinh, Austin, TX (US); Madhanmohan Reddy, Anantapur (IN)

(21) Appl. No.: 19/034,879

(22) Filed: Jan. 23, 2025

(51) Int. Cl. G06F 8/73; G06F 40/221; G06N 3/0475

(52) U.S. Cl. CPC G06F 8/73; G06F 40/221; G06N 3/0475

(57) ABSTRACT

Methods, apparatus, and processor-readable storage media for automated documentation generation using generative artificial intelligence are provided herein. An example computer-implemented method includes obtaining, from one or more web-based sources, data related to at least one system element using one or more web extraction techniques; generating content pertaining to the at least one system element by processing at least a portion of the obtained data using one or more generative artificial intelligence techniques; and automatically incorporating, using at least one document endpoint, at least a portion of the generated content into one or more portions of documentation related to the at least one system element.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

In contexts wherein numerous devices, components, solutions, etc. are continuously being developed and/or updated, documentation can serve important functions. However, conventional documentation approaches typically rely on resource-intensive processes which are error-prone and latency-inducing.

### SUMMARY

Illustrative embodiments of the disclosure provide techniques for automated documentation generation using generative artificial intelligence.

An exemplary computer-implemented method includes obtaining, from one or more web-based sources, data related to at least one system element using one or more web extraction techniques. The method also includes generating content pertaining to the at least one system element by processing at least a portion of the obtained data using one or more generative artificial intelligence techniques. Further, the method additionally includes automatically incorporating, using at least one document endpoint, at least a portion of the generated content into one or more portions of documentation related to the at least one system element.

Illustrative embodiments can provide significant advantages relative to conventional documentation approaches. For example, problems associated with error-prone and latency-inducing conventional processes are overcome in one or more embodiments through extracting contemporary data pertaining to an element from web sources and automatically generating documentation content for the element by processing the extracted data using generative artificial intelligence techniques.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for automated documentation generation using generative artificial intelligence in an illustrative embodiment.

FIG. 2 shows example system architecture in an illustrative embodiment.

FIG. 3 shows example pseudocode for application programming interface (API) generation in an illustrative embodiment.

FIG. 4 shows example pseudocode for JavaScript object notation (JSON) data extraction in an illustrative embodiment.

FIG. 5 shows example pseudocode for generating a data sample for a given element in an illustrative embodiment.

FIG. 6 shows example pseudocode for requesting a document endpoint page as hypertext markup language (HTML) in an illustrative embodiment.

FIG. 7 shows example pseudocode for implementing web data extraction techniques in an illustrative embodiment.

FIG. 8 shows example pseudocode for implementing a large language model (LLM) in an illustrative embodiment.

FIG. 9 shows example pseudocode for generating a system message using the LLM in an illustrative embodiment.

FIG. 10 shows example pseudocode for an example JSON input and a corresponding example JSON output in an illustrative embodiment.

FIG. 11 shows example pseudocode for initializing a document endpoint API in an illustrative embodiment.

FIG. 12 shows example pseudocode for generating an HTML template for an element page in an illustrative embodiment.

FIG. 13 shows example pseudocode for pushing data and creating a page on the document endpoint in an illustrative embodiment.

FIG. 14 shows an example generated output element page for a Kafka platform in an illustrative embodiment.

FIG. 15 shows an example generated output utility page for a Kafka integration tool with generated content in an illustrative embodiment.

FIG. 16 shows example pseudocode for creating and/or updating frequently asked questions (FAQs) using an LLM in an illustrative embodiment.

FIG. 17 shows example pseudocode for extracting FAQs from LLM responses in an illustrative embodiment.

FIG. 18 is a flow diagram of a process for automated documentation generation using generative artificial intelligence in an illustrative embodiment.

FIGS. 19 and 20 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

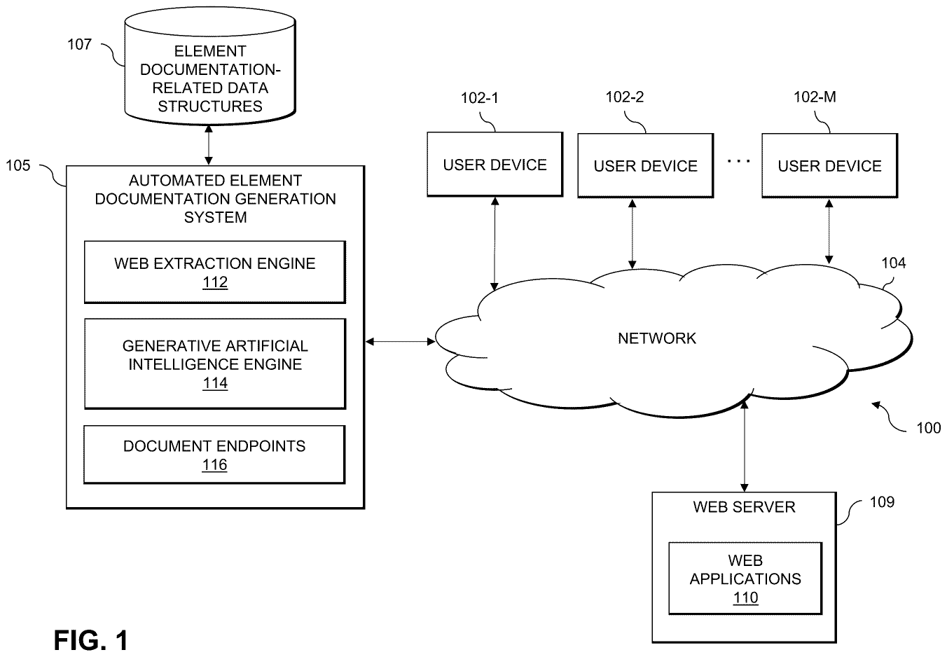

FIG. 1 shows a computer network (also referred to herein as an information processing system) 100 configured in accordance with an illustrative embodiment. The computer network 100 comprises a plurality of user devices 102-1, 102-2,. 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is automated element documentation generation system 105 and web server 109, upon which one or more web applications 110 (e.g., one or more smart catalog web applications, one or more element-related FAQ web applications, etc.) execute.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the automated element documentation generation system 105 can have one or more element documentation-related data structures 107 configured to store data pertaining to one or more given elements and documentation related thereto, such as, e.g., web-based data pertaining to the one or more given elements, generated documentation content pertaining to the one or more given elements, etc. The term “data structure,” as used herein, is intended to be broadly construed, so as to encompass, for example, a wide variety of different types of tables, arrays, graphs, trees, linked lists, and additional or alternative data relation mechanisms, as well as portions or combinations thereof. Accordingly, a given data structure can comprise a combination of multiple smaller data structures, possibly of different types, or a portion of a larger data structure. Numerous other arrangements are possible.

The element documentation-related data structures 107 in the present embodiment are implemented using one or more storage systems associated with the automated element documentation generation system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the automated element documentation generation system 105 are one or more input-output devices, which illustratively comprise keyboards, displays or other types of input-output devices in any combination. Such input-output devices can be used, for example, to support one or more user interfaces to the automated element documentation generation system 105, as well as to support communication between the automated element documentation generation system 105 and other related systems and devices not explicitly shown.

Additionally, the automated element documentation generation system 105 in the FIG. 1 embodiment is assumed to be implemented using at least one processing device. Each such processing device generally comprises at least one processor and an associated memory, and implements one or more functional modules for controlling certain features of the automated element documentation generation system 105.

More particularly, the automated element documentation generation system 105 in this embodiment can comprise a processor coupled to a memory and a network interface.

The processor may comprise, for example, a microprocessor, an application-specific integrated circuit (ASIC), a system-on-chip (SOC), a field-programmable gate array (FPGA), a central processing unit (CPU), a graphics processing unit (GPU), a neural processing unit (NPU), a data processing unit (DPU), a tensor processing unit (TPU), an arithmetic logic unit (ALU), a digital signal processor (DSP), and/or other similar processing device components, as well as other types and arrangements of processing circuitry, in any combination. At least a portion of the functionality of at least one artificial intelligence system and its associated artificial intelligence algorithms provided by one or more processing devices as disclosed herein can be implemented using such circuitry.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the automated element documentation generation system 105 to communicate over the network 104 with the user devices 102, and illustratively comprises one or more conventional transceivers.

The automated element documentation generation system 105 further comprises a web extraction engine 112, a generative artificial intelligence engine 114, and one or more document endpoints 116. As further detailed herein, web extraction engine 112 can be implemented to obtain element-related data from one or more web-based sources using one or more web extraction techniques. Also, generative artificial intelligence engine 114 can be implemented to automatically generate element-related content by processing data obtained via web extraction engine 112 and/or user-guided prompts. Further, the one or more document endpoints 116 can be implemented to automatically incorporate the generated content into one or more portions of element-related documentation.

It is to be appreciated that this particular arrangement of elements 112, 114 and 116 illustrated in the automated element documentation generation system 105 of the FIG. 1 embodiment is presented by way of example only, and alternative arrangements can be used in other embodiments. For example, the functionality associated with elements 112, 114 and 116 in other embodiments can be combined into a single module, or separated across a larger number of modules. As another example, multiple distinct processors can be used to implement different ones of elements 112, 114 and 116 or portions thereof.

At least portions of elements 112, 114 and 116 may be implemented at least in part in the form of software that is stored in memory and executed by a processor.

It is to be understood that the particular set of elements shown in FIG. 1 for automated documentation generation using generative artificial intelligence involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of automated element documentation generation system 105, element documentation-related data structures 107, and web server 109 can be on and/or part of the same processing platform.

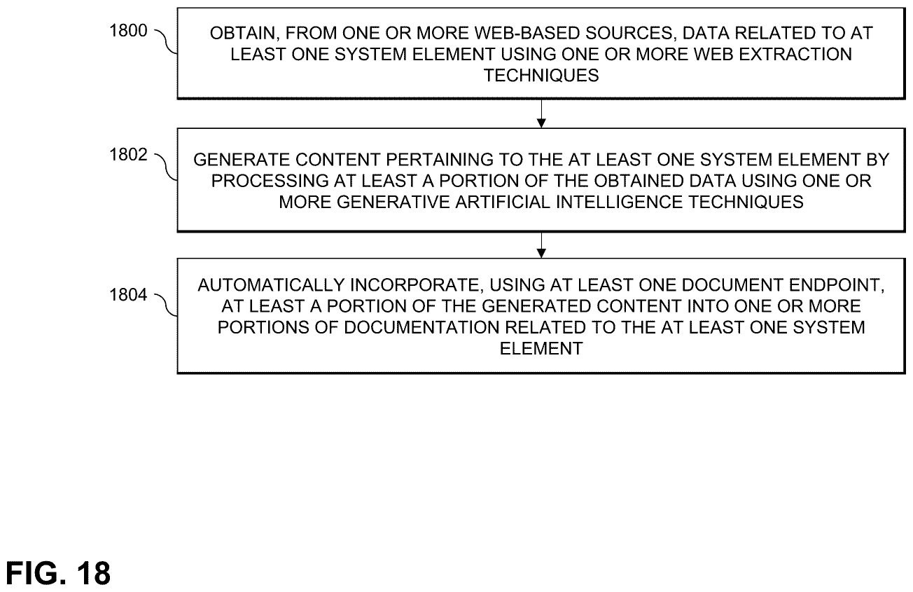

An exemplary process utilizing elements 112, 114 and 116 of an example automated element documentation generation system 105 in computer network 100 will be described in more detail with reference to the flow diagram of FIG. 18.

Accordingly, at least one embodiment includes automated documentation generation using generative artificial intelligence. Such an embodiment includes automating a documentation process by leveraging generative artificial intelligence to automatically generate comprehensive documentation for various elements including devices, components, solutions, etc. As used herein, documentation generally refers to text and/or graphical content pertaining to one or more designated topics and/or elements. Documentation, as used herein, can include, by way merely of example, electronic documentation, such as electronic documents, web pages, etc.

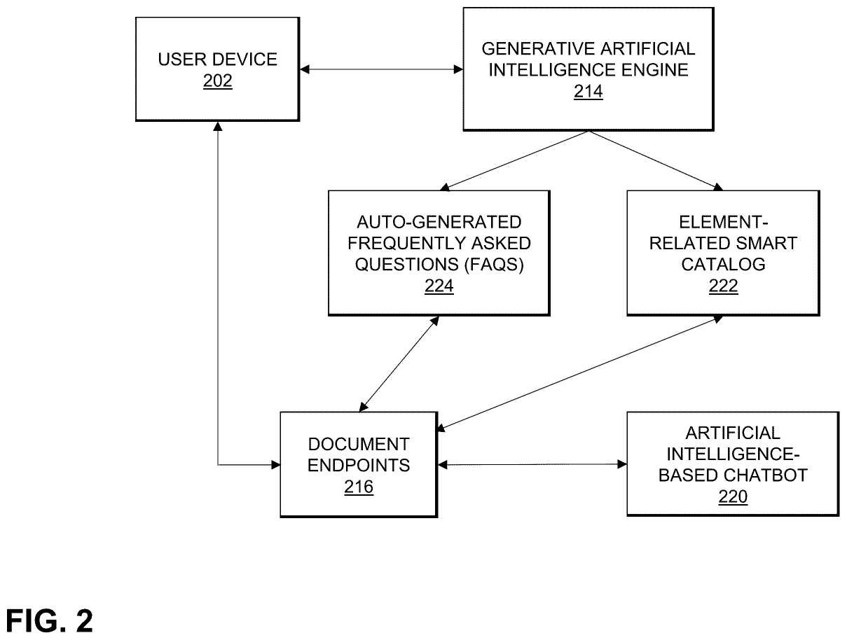

FIG. 2 shows example system architecture in an illustrative embodiment. By way of illustration, FIG. 2 depicts one or more user-guided element-related prompts being generated and/or provided by user device 202 to generative artificial intelligence engine 214 for processing. Based at least in part on such processing, the generative artificial intelligence engine 214 outputs one or more portions of an element-related smart catalog 222 and one or more auto-generated FAQs (and corresponding answers) 224. Such outputs are then provided to and/or processed via one or more document endpoints 216, which can provide access to such outputs to user device 202 and artificial intelligence-based chatbot 220.

In one or more embodiments, pre-existing data can be obtained and/or loaded using one or more web data extraction techniques. Additionally or alternatively, user-guided prompts (output by user device 202, for example) can also be utilized to trigger content generation via at least one LLM (e.g., as part of generative artificial intelligence engine 214), and such content can then be integrated with at least one API associated with a given device, component and/or solution in question. In such an embodiment, the generated content can also be pushed to update one or more documents dynamically via the one or more document endpoints 216. As used herein, a document endpoint refers to a uniform resource locator (URL) that at least one API exposes to interact with at least one software program and/or system.

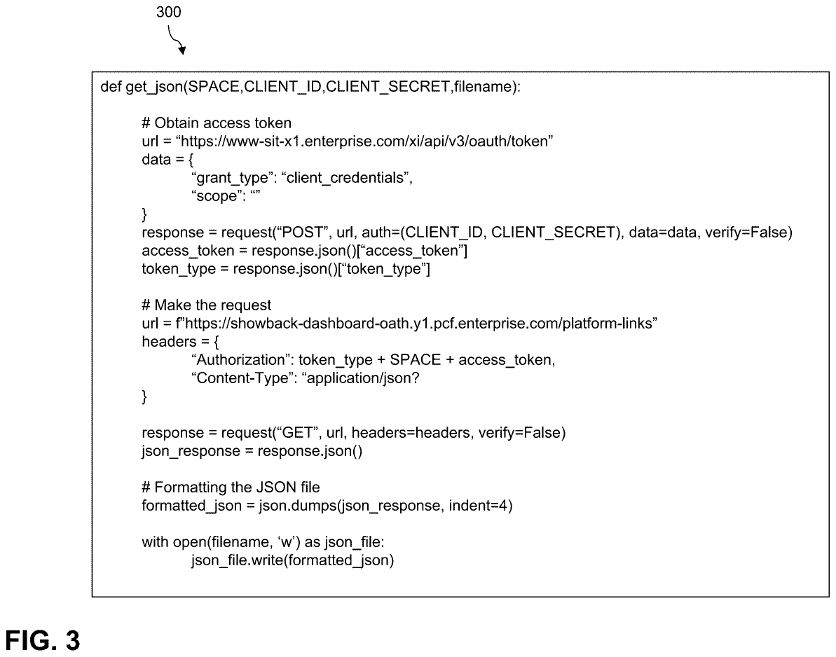

FIG. 3 shows example pseudocode for API generation in an illustrative embodiment. In this embodiment, example pseudocode 300 is executed by or under the control of at least one processing system and/or device. For example, the example pseudocode 300 may be viewed as comprising a portion of a software implementation of at least part of automated element documentation generation system 105 of the FIG. 1 embodiment.

The example pseudocode 300 illustrates creating an API of a given element (also referred to herein as product), wherein the API provides access to feature descriptions and summaries for the element. More particularly, example pseudocode 300 includes steps of obtaining an access token, making an authorization request related to the access token, and formatting a JSON response and/or output file. Updates and/or modifications to the element can be automatically reflected in the API output, ensuring that the element documentation remains up to date. Additionally, such actions can enable auto-generation of documentation, facilitating self-discovery of one or more new element features and/or changes, and enhancing user engagement and satisfaction.

It is to be appreciated that this particular example pseudocode shows just one example implementation of API generation, and alternative implementations can be used in other embodiments.

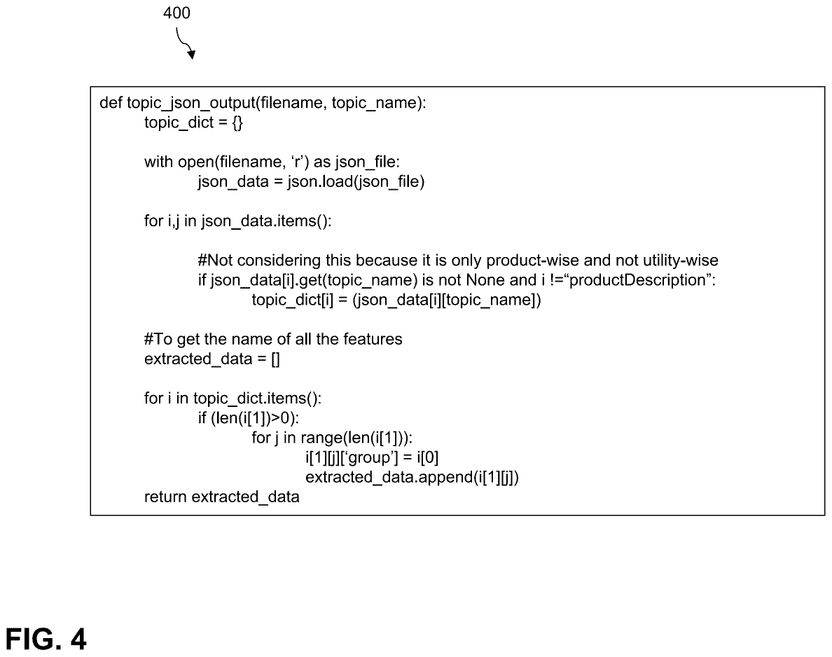

FIG. 4 shows example pseudocode for JSON data extraction in an illustrative embodiment. In this embodiment, example pseudocode 400 is executed by or under the control of at least one processing system and/or device. For example, the example pseudocode 400 may be viewed as comprising a portion of a software implementation of at least part of automated element documentation generation system 105 of the FIG. 1 embodiment.

The example pseudocode 400 illustrates extracting JSON data, wherein the JSON output in question can include one or more keys, and in every key there are one or more element-wise keys with respective utilities related thereto. Based at least in part on one or more needs pertaining to the data, one or more respective functions can be created to extract only such specific data from the JSON file. Accordingly, the example pseudocode 400 illustrates extracting such data for a selected element (“topic_name”) from the keys in the JSON file.

It is to be appreciated that this particular example pseudocode shows just one example implementation of JSON data extraction, and alternative implementations can be used in other embodiments.

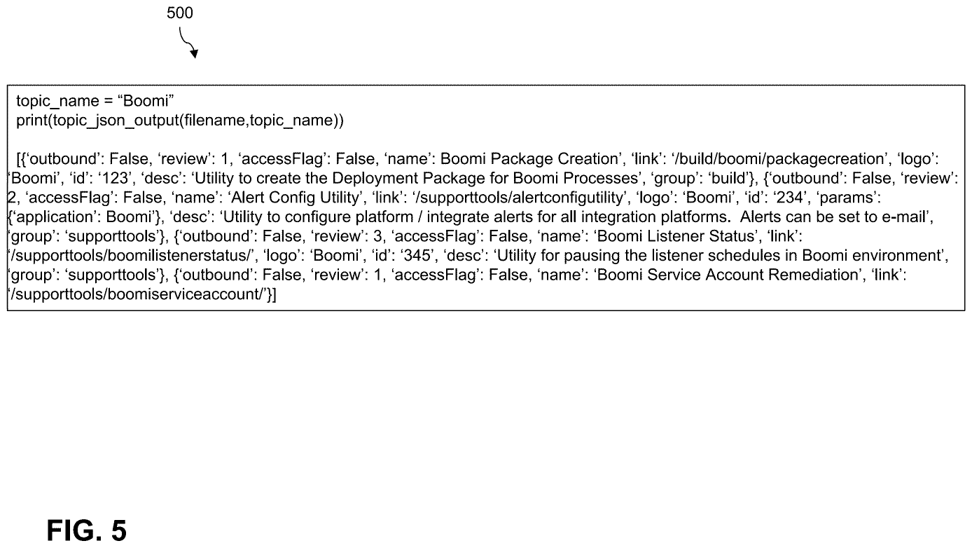

FIG. 5 shows example pseudocode for generating a data sample for a given element in an illustrative embodiment. In this embodiment, example pseudocode 500 is executed by or under the control of at least one processing system and/or device. For example, the example pseudocode 500 may be viewed as comprising a portion of a software implementation of at least part of automated element documentation generation system 105 of the FIG. 1 embodiment.

The example pseudocode 500 illustrates generating a data sample for a given element or element related to API management (e.g., Boomi) to determine and/or obtain its utilities and corresponding data. The generated list can be called in subsequent actions, for example, related to generating one or more smart catalogs.

It is to be appreciated that this particular example pseudocode shows just one example implementation of generating a data sample for a given element, and alternative implementations can be used in other embodiments.

Accordingly, one or more embodiments include implementing one or more document endpoint-related techniques and one or more web data extraction techniques. In such an embodiment, a document endpoint serves as a central hub for storing, retrieving, and/or updating generated content, ensuring data consistency and accessibility across various platforms and applications within at least one given context (e.g., within an enterprise system).

Also, by implementing one or more web data extraction techniques (including, for example, a Beautiful Soup library and/or other a Python library for extracting data out of HTML files and/or extensible markup language (XML) files), at least one embodiment can include fetching and/or obtaining useful data from diverse external sources. Such processes can improve and/or enrich content creation by infusing the content creation with recent information (e.g., the latest information), ensuring that generated documentation for devices, components and/or solutions (e.g., generated catalogs, FAQs, etc.) is not only precise but also contemporary. Through such integration, at least one embodiment also includes improving and/or elevating the user experience, offering insights into device, component and/or solution features and/or functionalities that are consistently up to date.

As detailed herein, one or more embodiments include using generative artificial intelligence techniques. Such an embodiment can include leveraging one or more LLMs to generate content based at least in part on one or more user prompts, ensuring efficiency and relevance to the content generation process. Once generated, the content can be used to generate new documents and/or can be integrated with existing documentation via at least one corresponding document endpoint, facilitating dynamic updates. Such an embodiment therefore includes not only enhancing the speed of content creation but also improving the accuracy and alignment of the content creation with one or more evolving and/or dynamic requirements.

Additionally or alternatively, at least one embodiment includes using retrieval-augmented generation (RAG) techniques for improving the quality of LLM-generated responses by grounding the LLM on one or more external sources of knowledge to supplement the LLM's internal representation of information. By implementing RAG techniques in connection with an LLM-based question answering system, such an embodiment includes ensuring that the LLM has access to the recent information (e.g., the most current, reliable facts related to a given device, component and/or solution in question). Further, in one or more embodiments, users can have access to the LLM's information sources, ensuring that the LLM's claims can be checked for accuracy and ultimately trusted.

Using RAG techniques on the existing database contents can enhance content precision by leveraging contextual understanding. By integrating RAG techniques with one or more LLMs, at least one embodiment includes refining the corresponding content generation process, enhancing relevance and accuracy tailored to specific user queries and/or needs.

Additionally, as detailed herein, one or more embodiments include implementing at least one web data extraction mechanism across multiple sources (e.g., all pages within a designated utility and/or website). Such an embodiment includes leveraging the capabilities of LLMs to generate content (e.g., FAQs) automatically based at least in part on the extracted data. Further, such generated content can then be integrated into particular documentation related to at least one given device, component and/or solution (e.g., a smart catalog for one or more device products).

Also, in at least one embodiment, a related chatbot (e.g., an on-premises chatbot) can reference the generated and/or updated documentation (e.g., the smart catalog), enhancing the capabilities of the chatbot to provide precise and in-depth answers. In such an embodiment, data can be converted to one or more vector embeddings that are derived from the documentation data, and the chatbot can incorporate at least one RAG system to further enrich user interactions. Such an integration facilitates users being able to access comprehensive and accurate information regarding the devices, components and/or solutions covered in the documentation (e.g., the smart catalog), thereby optimizing related resources and/or services (e.g., support and service delivery). Also, as noted above, the data being converted can include user-guided input query data derived, for example, from smart catalog documentation data, encompassing both structured and unstructured data. Such data transformation ensures the chatbot can leverage the entirety of the documentation's content, including dynamically updated product features, FAQs, and other contextual information, for enriched and precise user interactions.

Accordingly, one or more embodiments include enabling approximately real-time content updates and integration in connection with documentation generation. Such an embodiment can include ensuring that documentation and content therein remain current and accurately reflect the latest developments and/or updates with respect to corresponding devices, components and/or solutions, significantly reducing the lag time and other latencies associated with conventional approaches.

Additionally, at least one embodiment includes enhancing user engagement with documentation generation through the use of personalized content. By utilizing one or more LLMs and one or more generative artificial intelligence techniques, such an embodiment can include generating highly personalized and contextually relevant content tailored to one or more specific user queries and/or needs.

One or more embodiments can also include facilitating and/or implementing collaborative content creation and management by enabling multiple users (e.g., multiple stakeholders within an enterprise) to contribute to and update documentation dynamically. In such an embodiment, integrating generative artificial intelligence techniques ensures that contributions are consistent, accurate, and enriched with current information, fostering a more efficient and cohesive documentation process across users.

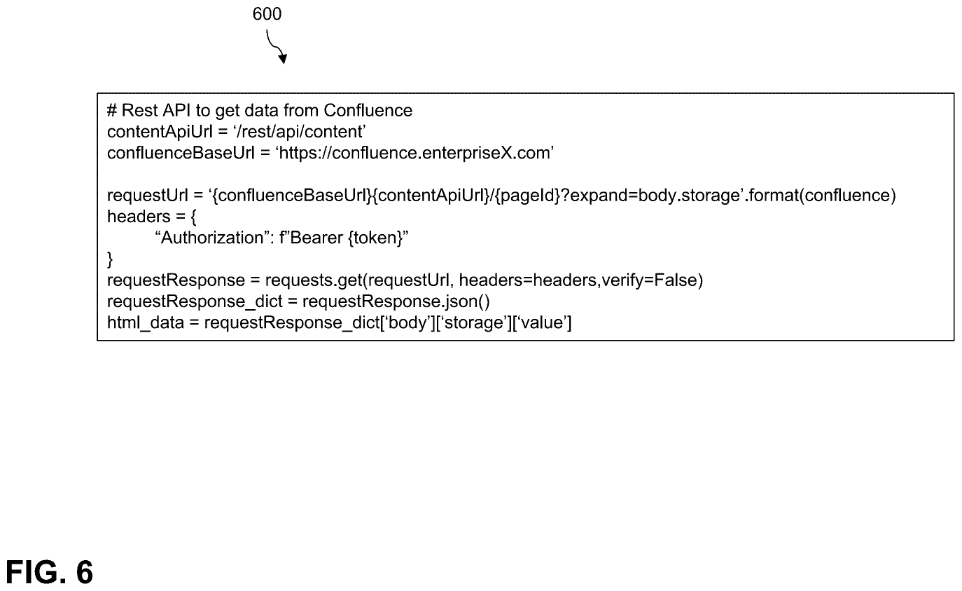

By way of illustration, and as further detailed below, FIG. 6 through FIG. 17 illustrate pseudocode related to an example use case involving an example document endpoint.

More particularly, consider an example embodiment which includes using a document endpoint (e.g., Confluence) to extract and update data of an integration as a service (INaaS) system, which can encompass and/or leverage different system elements (also referred to herein as products), each having different sets of utilities. Such an example embodiment can further include creating smart catalogs for these system elements and their utilities which are available via the INaaS. The pages of the smart catalogs can be updated, for example, if new element features are added or removed from the INaaS system.

Such an example embodiment can further include initializing at least one INaaS UI to select the element and at least one corresponding utility, to obtain and/or derive preexisting data related thereto from the page for that element utility. Additionally, at least one LLM call can be implemented to generate content from a user prompt related to that element utility.

FIG. 6 shows example pseudocode for requesting a document endpoint page as HTML in an illustrative embodiment. In this embodiment, example pseudocode 600 is executed by or under the control of at least one processing system and/or device. For example, the example pseudocode 600 may be viewed as comprising a portion of a software implementation of at least part of automated element documentation generation system 105 of the FIG. 1 embodiment.

The example pseudocode 600 illustrates implementing a call to retrieve data from at least one specific document endpoint page for the selected element and its utility. Such an action returns a dictionary wherein the HTML data for that at least one page can be provided and/or obtained. Additionally, in example pseudocode 600, a personal access token is used for the given document endpoint account.

It is to be appreciated that this particular example pseudocode shows just one example implementation of requesting a document endpoint page as HTML, and alternative implementations can be used in other embodiments.

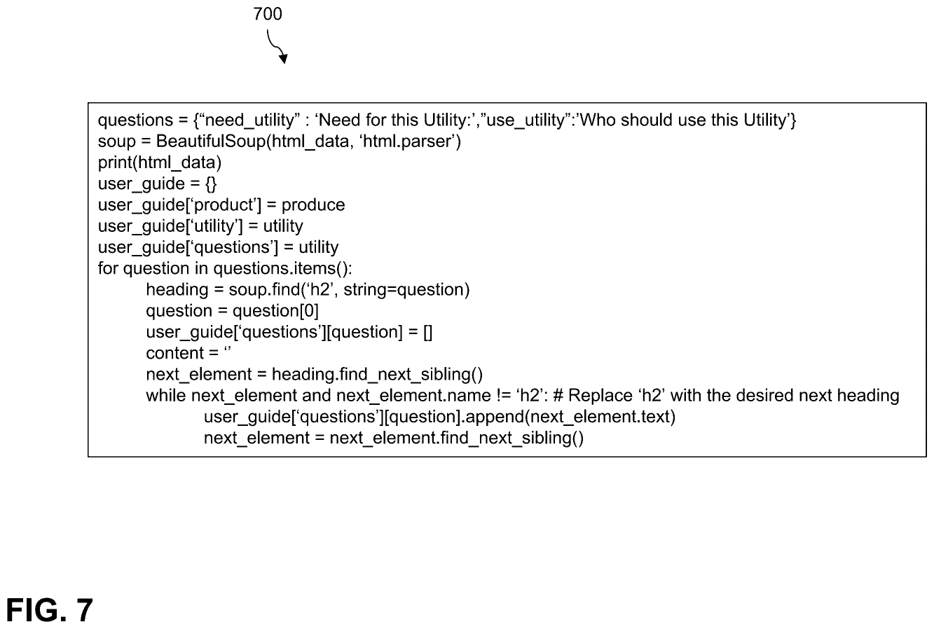

FIG. 7 shows example pseudocode for implementing web data extraction techniques in an illustrative embodiment. In this embodiment, example pseudocode 700 is executed by or under the control of at least one processing system and/or device. For example, the example pseudocode 700 may be viewed as comprising a portion of a software implementation of at least part of automated element documentation generation system 105 of the FIG. 1 embodiment.

The example pseudocode 700 illustrates using “Beautiful Soup,” a Python library for parsing and/or extracting data from HTML and XML files, to parse through the HTML data (such as retrieved and/or output in example pseudocode 600 of FIG. 6) and extract answers under respective headings, storing such answers in at least one dictionary (“user_guide”) to be returned as a JSON file.

It is to be appreciated that this particular example pseudocode shows just one example implementation of web data extraction techniques, and alternative implementations can be used in other embodiments.

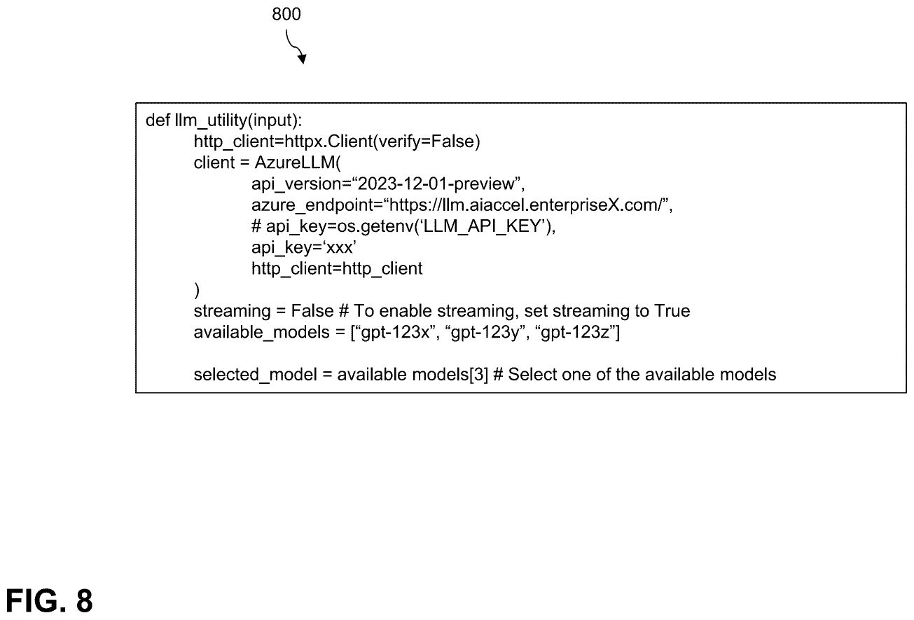

FIG. 8 shows example pseudocode for implementing an LLM in an illustrative embodiment. In this embodiment, example pseudocode 800 is executed by or under the control of at least one processing system and/or device. For example, the example pseudocode 800 may be viewed as comprising a portion of a software implementation of at least part of automated element documentation generation system 105 of the FIG. 1 embodiment.

The example pseudocode 800 illustrates implementing a call to make an LLM call to generate content for a specific question on a given page. For example, example pseudocode 800 includes implementing a “llm_utility” function to generate an answer for a question.

It is to be appreciated that this particular example pseudocode shows just one example implementation of an LLM, and alternative implementations can be used in other embodiments.

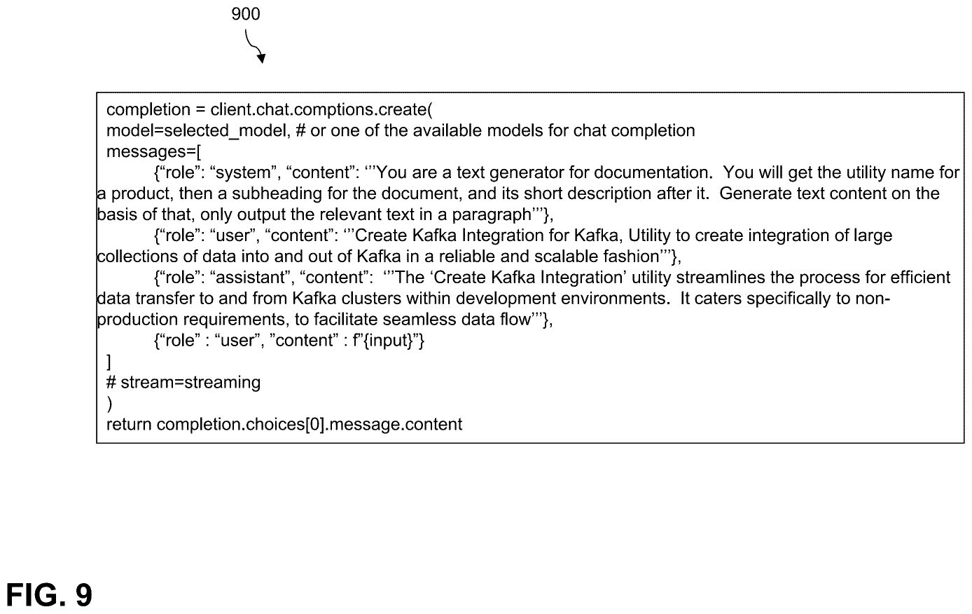

FIG. 9 shows example pseudocode for generating a system message using the LLM in an illustrative embodiment. In this embodiment, example pseudocode 900 is executed by or under the control of at least one processing system and/or device. For example, the example pseudocode 900 may be viewed as comprising a portion of a software implementation of at least part of automated element documentation generation system 105 of the FIG. 1 embodiment.

The example pseudocode 900 illustrates steps for generating a prompt for the LLM to generate content in a particular style and format. For instance, example pseudocode 900 includes selecting the LLM as well as the role and corresponding content type(s).

It is to be appreciated that this particular example pseudocode shows just one example implementation of generating a system message using the LLM, and alternative implementations can be used in other embodiments.

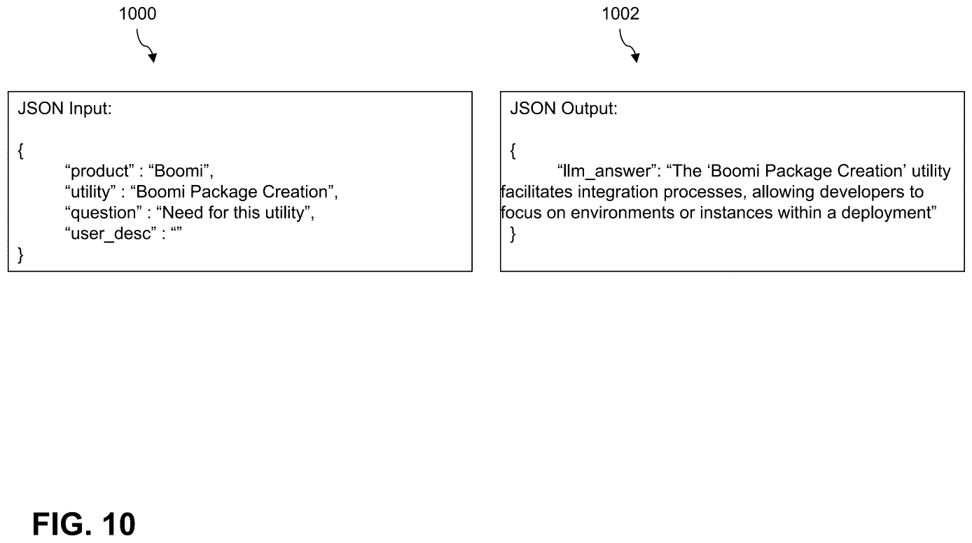

FIG. 10 shows example pseudocode for an example JSON input 1000 and a corresponding example JSON output 1002 in an illustrative embodiment. In this embodiment, example pseudocode is executed by or under the control of at least one processing system and/or device. For example, the example pseudocode may be viewed as comprising a portion of a software implementation of at least part of automated element documentation generation system 105 of the FIG. 1 embodiment.

The example pseudocode illustrates an example JSON input 1000 to be used in connection with the prompt to the LLM, wherein such an example JSON input 1000 includes the element and utility name, along with the respective question and the user description entered on the INaaS user interface. The example pseudocode illustrates an example JSON 1002 output which includes a generated answer to the input question, further based at least in part on the other details of the example JSON input 1000.

It is to be appreciated that this particular example pseudocode shows just one example implementation of a JSON input and a corresponding JSON output, and alternative implementations can be used in other embodiments.

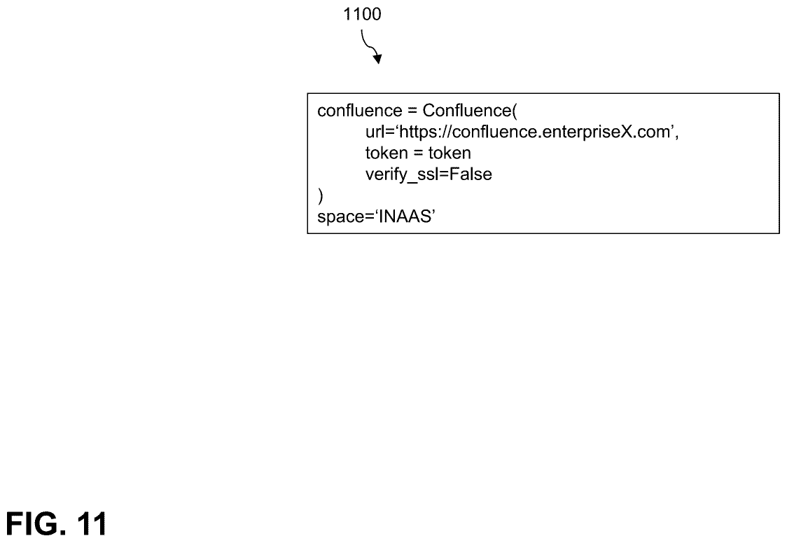

FIG. 11 shows example pseudocode for initializing a document endpoint API in an illustrative embodiment. In this embodiment, example pseudocode 1100 is executed by or under the control of at least one processing system and/or device. For example, the example pseudocode 1100 may be viewed as comprising a portion of a software implementation of at least part of automated element documentation generation system 105 of the FIG. 1 embodiment.

The example pseudocode 1100 illustrates implementing a call to push updated content on the respective document endpoint page. For example, such updated content can be used to generate FAQs on the element page. Also, in one or more embodiments, formatting and pushing data to the respective document endpoint page includes importing information pertaining to the document endpoint from a given software development system, and identifying a “token,” as illustrated in example pseudocode 1100, as the personal access token for the administrator document endpoint account. Further, example pseudocode 1100 includes specifying the space as INaaS.

It is to be appreciated that this particular example pseudocode shows just one example implementation of initializing a document endpoint API, and alternative implementations can be used in other embodiments.

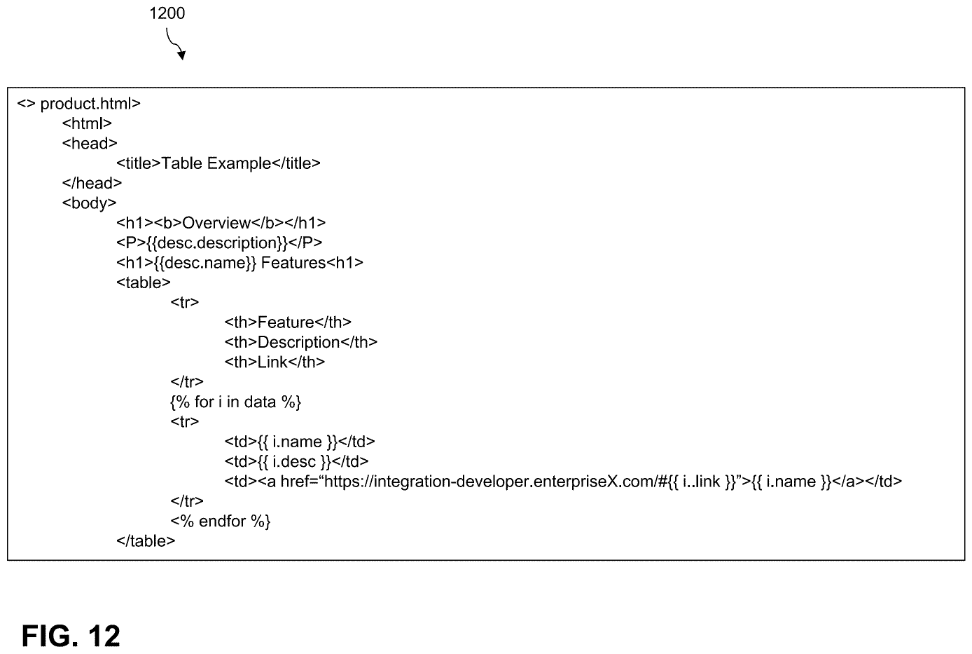

FIG. 12 shows example pseudocode for generating an HTML template for an element page in an illustrative embodiment. In this embodiment, example pseudocode 1200 is executed by or under the control of at least one processing system and/or device. For example, the example pseudocode 1200 may be viewed as comprising a portion of a software implementation of at least part of automated element documentation generation system 105 of the FIG. 1 embodiment.

The example pseudocode 1200 illustrates generating an HTML template for the element page and its utility pages, wherein the HTML template will ultimately take values from the corresponding Python code and/or the LLM output. Accordingly, in at least one embodiment, example pseudocode 1200 includes generating at least one page with at least one overview and at least one table with the utilities under that element, in addition to respective descriptions and links.

It is to be appreciated that this particular example pseudocode shows just one example implementation of generating an HTML template for an element page, and alternative implementations can be used in other embodiments.

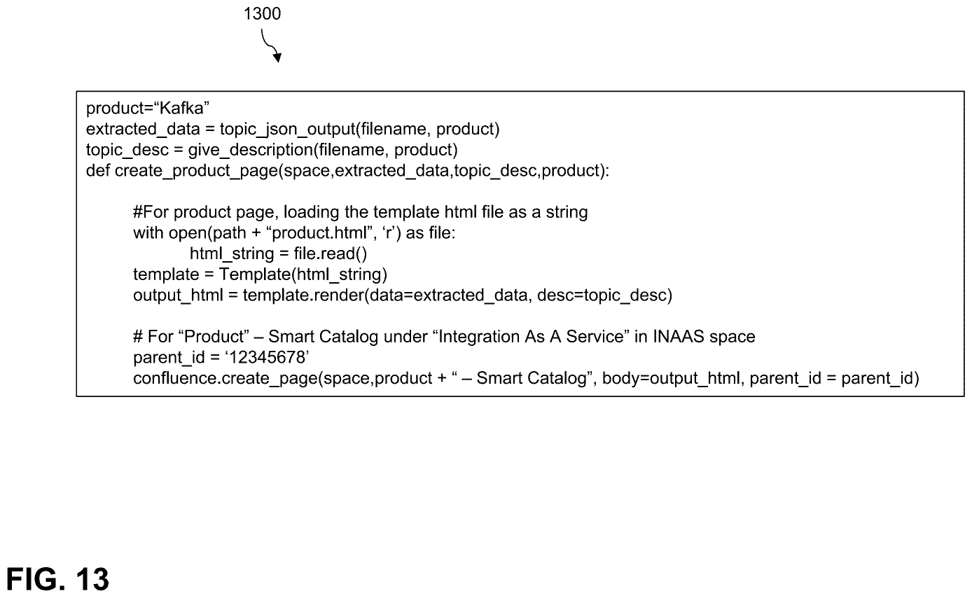

FIG. 13 shows example pseudocode for pushing data and creating a page on the document endpoint in an illustrative embodiment. In this embodiment, example pseudocode 1300 is executed by or under the control of at least one processing system and/or device. For example, the example pseudocode 1300 may be viewed as comprising a portion of a software implementation of at least part of automated element documentation generation system 105 of the FIG. 1 embodiment.

The example pseudocode 1300 illustrates creating one or more pages for the selected element and the element's utilities. More particularly, example pseudocode 1300 includes creating a product page for a data processing platform (e.g., Kafka), which includes loading a template HTML file as a string and generating a corresponding smart catalog and/or smart catalog entry in an INaaS space.

It is to be appreciated that this particular example pseudocode shows just one example implementation of pushing data and creating a page on the document endpoint, and alternative implementations can be used in other embodiments.

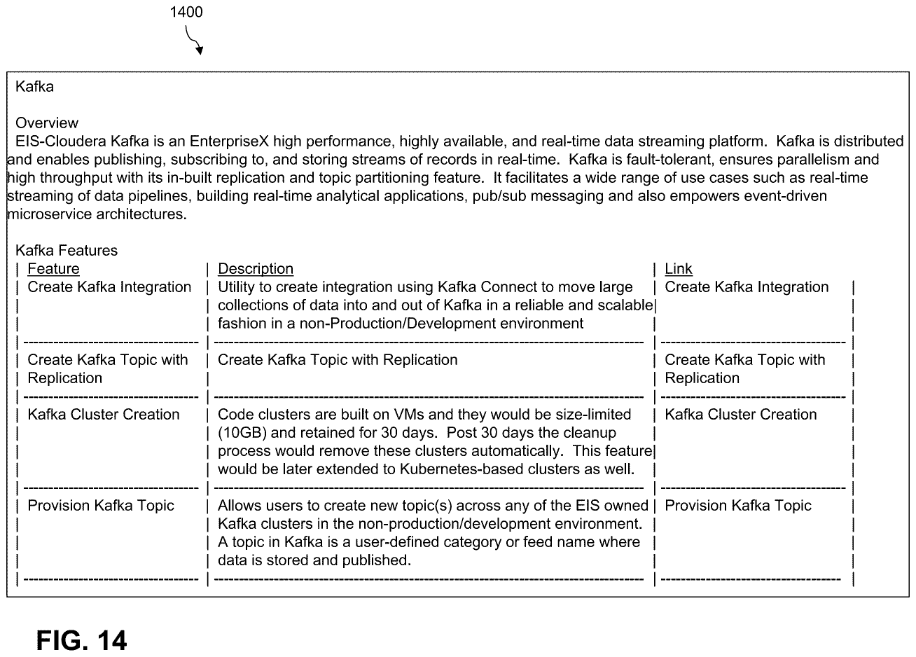

FIG. 14 shows an example generated output element page for a Kafka platform in an illustrative embodiment. By way of illustration, FIG. 14 depicts example generated output element page 1400 which includes describing a Kafka integration tool which facilitates moving large amounts of data into and out of a Kafka platform efficiently. Further, the example generated output element page 1400 includes identification of particular features of the Kafka tool, as well as corresponding descriptions of those features and links to access those features, generated in a tabular format.

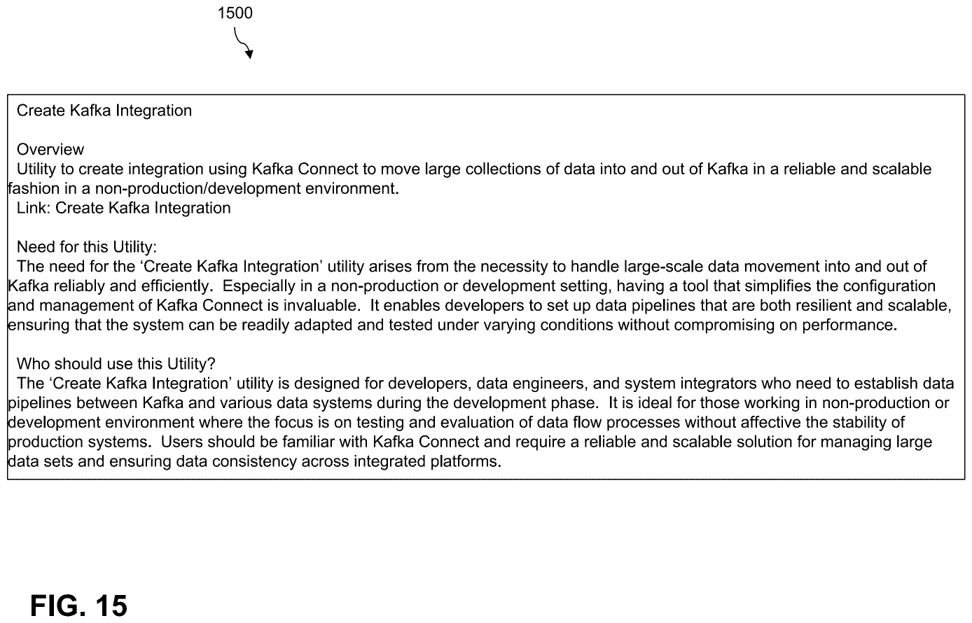

FIG. 15 shows an example generated output utility page 1500 for a Kafka integration tool with generated content in an illustrative embodiment. By way of illustration, FIG. 15 depicts an example output utility page 1500 which was created with the help of one or more user-guided prompts and at least one LLM. More particularly, FIG. 15 depicts a list of FAQ-style questions and answers for a product page for the create Kafka integration tool.

More particularly, example generated output utility page 1500 can be generated, in one or more embodiments, using at least one artificial intelligence model to create the corresponding code. Such an embodiment includes selecting an artificial intelligence model (e.g., a generative pre-trained transformer (GPT)) and configuring the model for generating text based completions. Subsequently, instructions are provided to the configured model, wherein, e.g., a system message instructs the model of the role that the model should plan. In the example depicted in FIG. 15, the model is instructed to act as an FAQ generator for a create Kafka integration tool page.

Additionally, such an embodiment also includes inputting the tool/product description to the model (e.g., “The Create Kafka Integration utility streamlines data transfer to and from Kafka within development environments.”), and the model is instructed to generate specific questions about the tool/product, along with instructions to generate matching answers. By way merely of example, such a generated question can include “Why is the Create Kafka Integration utility used?” and the corresponding generated answer can include that “This utility is used to streamline the process of configuring Kafka clusters for efficient data transfer.” These FAQs can then be integrated into the product's documentation and/or displayed on a webpage for user reference, such as depicted in the example in FIG. 15.

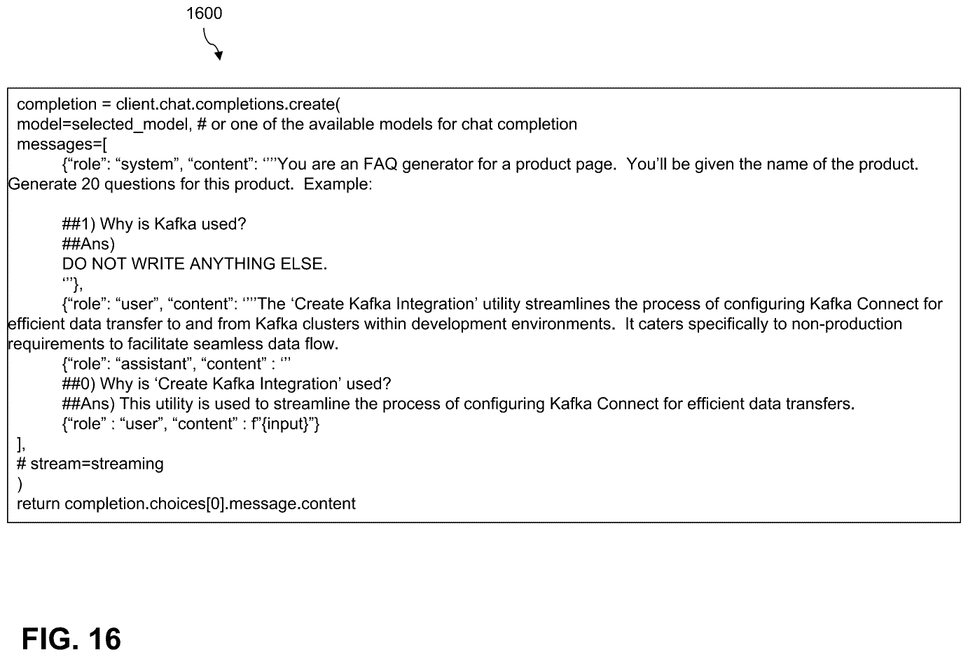

FIG. 16 shows example pseudocode for creating and/or updating FAQs using an LLM in an illustrative embodiment. In this embodiment, example pseudocode 1600 is executed by or under the control of at least one processing system and/or device. For example, the example pseudocode 1600 may be viewed as comprising a portion of a software implementation of at least part of automated element documentation generation system 105 of the FIG. 1 embodiment.

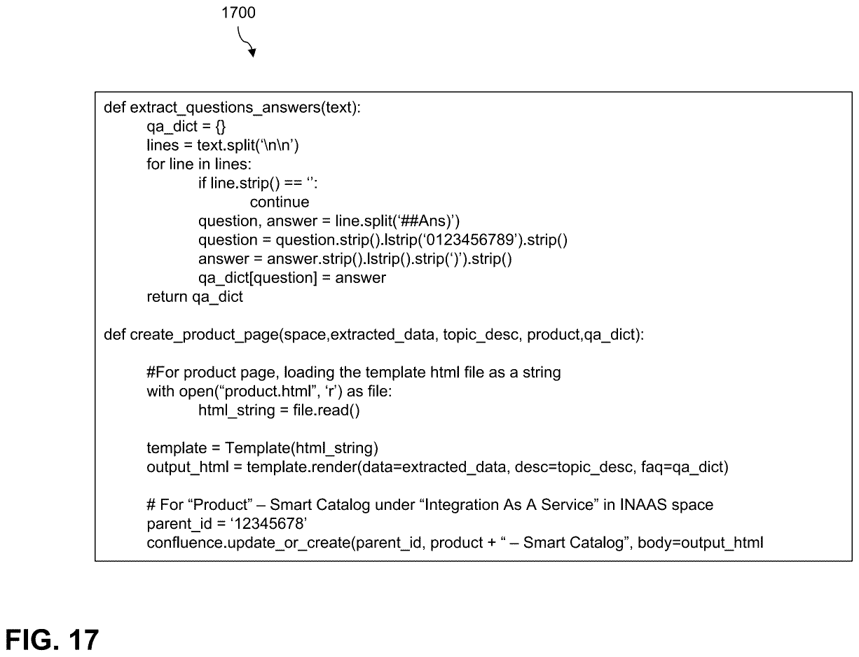

The example pseudocode 1600 illustrates using at least one LLM to create and/or update one or more FAQs at the end of a push on the document endpoint. At least one embodiment can include iterating through elements and their utilities to store relevant content in a single string (e.g., “llm_input”) that will subsequently be passed to the at least one LLM. For instance, example pseudocode 1600 includes instructions passed to make an LLM generate twenty FAQs on updated data after passing an “llm_input” in a pre-defined structure (e.g., separated by ## in example pseudocode 1600), to be used in connection with subsequently extracting the questions and answers from the LLM output (e.g., as detailed in connection with FIG. 17).

It is to be appreciated that this particular example pseudocode shows just one example implementation of creating and/or updating FAQs using an LLM, and alternative implementations can be used in other embodiments.

FIG. 17 shows example pseudocode for extracting FAQs from LLM responses in an illustrative embodiment. In this embodiment, example pseudocode 1700 is executed by or under the control of at least one processing system and/or device. For example, the example pseudocode 1700 may be viewed as comprising a portion of a software implementation of at least part of automated element documentation generation system 105 of the FIG. 1 embodiment.

The example pseudocode 1700 illustrates extracting questions and answers from LLM output, and adding one or more automatically generated FAQs to at least one related element page.

It is to be appreciated that this particular example pseudocode shows just one example implementation of extracting FAQs from LLM responses, and alternative implementations can be used in other embodiments.

FIG. 18 is a flow diagram of a process for automated documentation generation using generative artificial intelligence in an illustrative embodiment. It is to be understood that this particular process is only an example, and additional or alternative processes can be carried out in other embodiments.

In this embodiment, the process includes steps 1800 through 1804. These steps are assumed to be performed by the automated element documentation generation system 105 utilizing elements 112, 114 and 116.

Step 1800 includes obtaining, from one or more web-based sources, data related to at least one system element using one or more web extraction techniques. In at least one embodiment, obtaining data related to at least one system element includes extracting, using the one or more web extraction techniques, data related to at least one system element from at least one of one or more HTML files and one or more XML files. Also, in at least one embodiment, the at least one system element can include at least one of one or more devices, one or more system components, and system-related software.

Step 1802 includes generating content pertaining to the at least one system element by processing at least a portion of the obtained data using one or more generative artificial intelligence techniques. In one or more embodiments, generating content pertaining to the at least one system element includes processing the at least a portion of the obtained data using one or more one or more LLMs. In such an embodiment, generating content pertaining to the at least one system element can include supplementing at least a portion of the content, generated using the one or more LLMs, using one or more RAG techniques trained on one or more designated data sources. Additionally or alternatively, generating content pertaining to the at least one system element can include processing at least a portion of the obtained data and one or more user-guided prompts using one or more generative artificial intelligence techniques.

Further, in one or more embodiments, in addition to or as an alternative to LLMs, one or more separate generative artificial intelligence techniques can be implemented. For example, such generative artificial intelligence techniques can include one or more vector embedding models (e.g., one or more sentence transformers), one or more RAG frameworks (e.g., Haystack, FAISS, etc.), one or more generative image models (e.g., stable diffusion), one or more summarization algorithms (e.g., one or more bidirectional and autoregressive transformations), one or more FAQ generation models (e.g., one or more encoder-decoder models, one or more GPTs, etc.), one or more web scraping and data extraction algorithms (e.g., Beautiful Soup), one or more content personalization algorithms (e.g., one or more deep learning recommendation models (DLRMs)), one or more knowledge graph construction and management models (e.g., one or more resource description framework-based graph models), one or more automated translation models (e.g., Marian MT and/or DeepL APIs), one or more feedback-driven content optimization models (e.g., one or more reinforcement learning with human feedback (RLHF) models), etc.

Step 1804 includes automatically incorporating, using at least one document endpoint, at least a portion of the generated content into one or more portions of documentation related to the at least one system element. In at least one embodiment, automatically incorporating at least a portion of the generated content into one or more portions of documentation related to the at least one system element includes automatically integrating, using the at least one document endpoint, the at least a portion of the generated content with at least one API associated with the at least one system element. Additionally or alternatively, automatically incorporating at least a portion of the generated content into one or more portions of documentation related to the at least one system element can include using the at least one document endpoint to one or more of automatically generate at least one new item of documentation based at least in part on the at least a portion of the generated content and automatically integrate the at least a portion of the generated content with one or more portions of existing documentation.

In one or more embodiments, the techniques depicted in FIG. 18 can also include configuring at least one chatbot related to the at least one system element to access the one or more portions of documentation related to the at least one system element subsequent to the incorporating of the at least a portion of the generated content. In such an embodiment, configuring the at least one chatbot can include configuring the at least one chatbot to convert one or more portions of input data to one or more vector embeddings are derived from the one or more portions of documentation related to the at least one system element subsequent to the incorporating of the at least a portion of the generated content.

Further, in at least one embodiment, the techniques depicted in FIG. 18 can also include automatically training at least a portion of the one or more generative artificial intelligence techniques based at least in part on feedback related to the one or more portions of documentation related to the at least one system element subsequent to the incorporating of the at least a portion of the generated content.

Accordingly, the particular processing operations and other functionality described in conjunction with the flow diagram of FIG. 18 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to extract contemporary data pertaining to an element from web sources and automatically generate documentation content for the element by processing the extracted data using generative artificial intelligence techniques. These and other embodiments can effectively overcome problems associated with error-prone and latency-inducing conventional processes.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

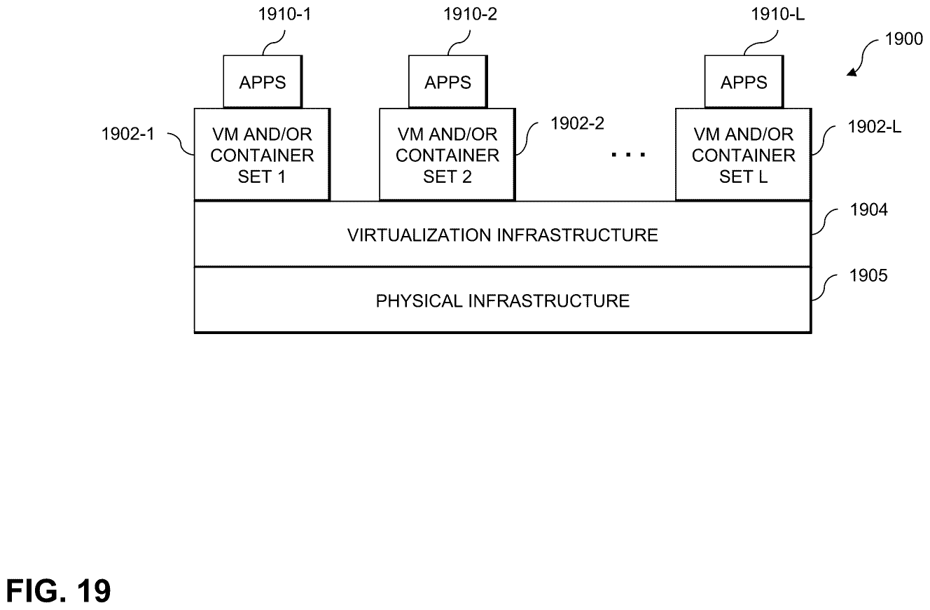

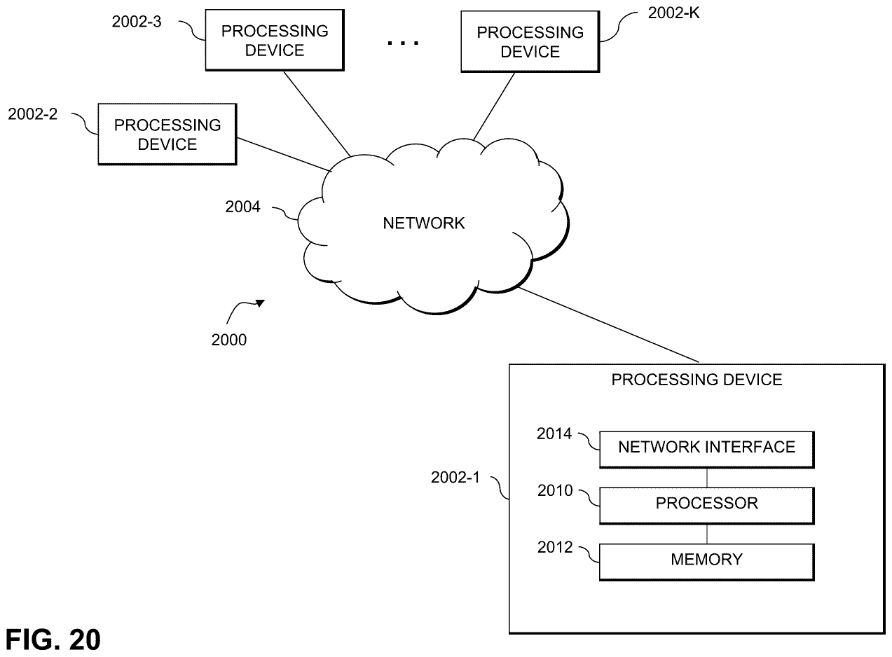

Illustrative embodiments of processing platforms will now be described in greater detail with reference to FIGS. 19 and 20. Although described in the context of system 100, these platforms may also be used to implement at least portions of other information processing systems in other embodiments.

FIG. 19 shows an example processing platform comprising cloud infrastructure 1900. The cloud infrastructure 1900 comprises a combination of physical and virtual processing resources that are utilized to implement at least a portion of the information processing system 100. The cloud infrastructure 1900 comprises multiple virtual machines (VMs) and/or container sets 1902-1, 1902-2,. 1902-L implemented using virtualization infrastructure 1904. The virtualization infrastructure 1904 runs on physical infrastructure 1905, and illustratively comprises one or more hypervisors and/or operating system level virtualization infrastructure. The operating system level virtualization infrastructure illustratively comprises kernel control groups of a Linux operating system or other type of operating system.

The cloud infrastructure 1900 further comprises sets of applications 1910-1, 1910-2,. 1910-L running on respective ones of the VMs/container sets 1902-1, 1902-2,. 1902-L under the control of the virtualization infrastructure 1904. The VMs/container sets 1902 comprise respective VMs, respective sets of one or more containers, or respective sets of one or more containers running in VMs. In some implementations of the FIG. 19 embodiment, the VMs/container sets 1902 comprise respective VMs implemented using virtualization infrastructure 1904 that comprises at least one hypervisor.

A hypervisor platform may be used to implement a hypervisor within the virtualization infrastructure 1904, wherein the hypervisor platform has an associated virtual infrastructure management system. The underlying physical machines comprise one or more information processing platforms that include one or more storage systems.

In other implementations of the FIG. 19 embodiment, the VMs/container sets 1902 comprise respective containers implemented using virtualization infrastructure 1904 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 1900 shown in FIG. 19 may represent at least a portion of one processing platform. Another example of such a processing platform is processing platform 2000 shown in FIG. 20.

The processing platform 2000 in this embodiment comprises a portion of system 100 and includes a plurality of processing devices, denoted 2002-1, 2002-2, 2002-3, . . . 2002-K, which communicate with one another over a network 2004.

The network 2004 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 2002-1 in the processing platform 2000 comprises a processor 2010 coupled to a memory 2012.

The processor 2010 comprises a microprocessor, an ASIC, an SOC, an FPGA, a CPU, a GPU, an NPU, a DPU, a TPU, an ALU, a DSP, and/or other similar processing device components, as well as other types and arrangements of processing circuitry, in any combination. At least a portion of the functionality of at least one artificial intelligence system and its associated artificial intelligence algorithms provided by one or more processing devices as disclosed herein can be implemented using such circuitry.

The memory 2012 comprises RAM, ROM or other types of memory, in any combination. The memory 2012 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 2002-1 is network interface circuitry 2014, which is used to interface the processing device with the network 2004 and other system components, and may comprise conventional transceivers.

The other processing devices 2002 of the processing platform 2000 are assumed to be configured in a manner similar to that shown for processing device 2002-1 in the figure.

Again, the particular processing platform 2000 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
obtaining, from one or more web-based sources, data related to at least one system element using one or more web extraction techniques;
generating content pertaining to the at least one system element by processing at least a portion of the obtained data using one or more generative artificial intelligence techniques; and
automatically incorporating, using at least one document endpoint, at least a portion of the generated content into one or more portions of documentation related to the at least one system element;
wherein the method is performed by at least one processing device comprising a processor coupled to a memory.

2. The computer-implemented method of claim 1, wherein generating content pertaining to the at least one system element comprises processing the at least a portion of the obtained data using one or more one or more large language models (LLMs).

3. The computer-implemented method of claim 2, wherein generating content pertaining to the at least one system element comprises supplementing at least a portion of the content, generated using the one or more LLMs, using one or more retrieval-augmented generation (RAG) techniques trained on one or more designated data sources.

4. The computer-implemented method of claim 1, wherein generating content pertaining to the at least one system element comprises processing at least a portion of the obtained data and one or more user-guided prompts using one or more generative artificial intelligence techniques.

5. The computer-implemented method of claim 1, wherein automatically incorporating at least a portion of the generated content into one or more portions of documentation related to the at least one system element comprises automatically integrating, using the at least one document endpoint, the at least a portion of the generated content with at least one application programming interface (API) associated with the at least one system element.

6. The computer-implemented method of claim 1, wherein automatically incorporating at least a portion of the generated content into one or more portions of documentation related to the at least one system element comprises using the at least one document endpoint to one or more of automatically generate at least one new item of documentation based at least in part on the at least a portion of the generated content and automatically integrate the at least a portion of the generated content with one or more portions of existing documentation.

7. The computer-implemented method of claim 1, further comprising:
configuring at least one chatbot related to the at least one system element to access the one or more portions of documentation related to the at least one system element subsequent to the incorporating of the at least a portion of the generated content.

8. The computer-implemented method of claim 7, wherein configuring the at least one chatbot comprises configuring the at least one chatbot to convert one or more portions of input data to one or more vector embeddings are derived from the one or more portions of documentation related to the at least one system element subsequent to the incorporating of the at least a portion of the generated content.

9. The computer-implemented method of claim 1, wherein obtaining data related to at least one system element comprises extracting, using the one or more web extraction techniques, data related to at least one system element from at least one of one or more hypertext markup language (HTML) files and one or more extensible markup language (XML) files.

10. The computer-implemented method of claim 1, wherein the at least one system element comprises at least one of one or more devices, one or more system components, and system-related software.

11. The computer-implemented method of claim 1, further comprising:
automatically training at least a portion of the one or more generative artificial intelligence techniques based at least in part on feedback related to the one or more portions of documentation related to the at least one system element subsequent to the incorporating of the at least a portion of the generated content.

12. A non-transitory processor-readable storage medium having stored therein program code of one or more software programs, wherein the program code when executed by at least one processing device causes the at least one processing device:
to obtain, from one or more web-based sources, data related to at least one system element using one or more web extraction techniques;
to generate content pertaining to the at least one system element by processing at least a portion of the obtained data using one or more generative artificial intelligence techniques; and
to automatically incorporate, using at least one document endpoint, at least a portion of the generated content into one or more portions of documentation related to the at least one system element.

13. The non-transitory processor-readable storage medium of claim 12, wherein generating content pertaining to the at least one system element comprises processing the at least a portion of the obtained data using one or more one or more large language models (LLMs).

14. The non-transitory processor-readable storage medium of claim 13, wherein generating content pertaining to the at least one system element comprises supplementing at least a portion of the content, generated using the one or more LLMs, using one or more retrieval-augmented generation (RAG) techniques trained on one or more designated data sources.

15. The non-transitory processor-readable storage medium of claim 12, wherein automatically incorporating at least a portion of the generated content into one or more portions of documentation related to the at least one system element comprises automatically integrating, using the at least one document endpoint, the at least a portion of the generated content with at least one application programming interface (API) associated with the at least one system element.

16. The non-transitory processor-readable storage medium of claim 12, wherein the program code when executed by the at least one processing device further causes the at least one processing device:
to configure at least one chatbot related to the at least one system element to access the one or more portions of documentation related to the at least one system element subsequent to the incorporating of the at least a portion of the generated content.

17. An apparatus comprising:
at least one processing device comprising a processor coupled to a memory;
the at least one processing device being configured:
to obtain, from one or more web-based sources, data related to at least one system element using one or more web extraction techniques;
to generate content pertaining to the at least one system element by processing at least a portion of the obtained data using one or more generative artificial intelligence techniques; and
to automatically incorporate, using at least one document endpoint, at least a portion of the generated content into one or more portions of documentation related to the at least one system element.

18. The apparatus of claim 17, wherein generating content pertaining to the at least one system element comprises processing the at least a portion of the obtained data using one or more one or more large language models (LLMs).

19. The apparatus of claim 17, wherein automatically incorporating at least a portion of the generated content into one or more portions of documentation related to the at least one system element comprises automatically integrating, using the at least one document endpoint, the at least a portion of the generated content with at least one application programming interface (API) associated with the at least one system element.

20. The apparatus of claim 17, wherein the at least one processing device is further configured:
to configure at least one chatbot related to the at least one system element to access the one or more portions of documentation related to the at least one system element subsequent to the incorporating of the at least a portion of the generated content.
